(19) United States
(12) Patent Application Publication
(10) Pub. No.: US 2002/0067224 A1
(43) Pub. Date: Jun. 6, 2002

(54) System and method for scanner executing scanning

(75) Inventor: Hui-Wen Wen, Hsin-Chu (TW)

Correspondence Address: Benjamin J. Hauptman, LOWE HAUPTMAN GILMAN & BERNER, 1700 Diagonal Road, Suite 310, Alexandria, VA, 22314, US

(73) Assignee: Mustek Systems Inc.

(21) Appl. No.: 09/729,830

(22) Filed: Dec. 6, 2000

(51) Int. Cl. H04B 1/52

(52) U.S. Cl. 333/118

(57) ABSTRACT

In the present invention, a system for a scanner executing scanning comprises a virtual hardware module in an electrical apparatus, and the virtual hardware module is corresponding to the scanner and used for receiving a plurality of commands from the electrical apparatus. The virtual hardware module is displayed on the electrical apparatus. A scanner control module in the electrical apparatus is for communicating with the scanner via the electrical apparatus and the virtual hardware module. The scanner control module is for controlling and executing the commands from the virtual hardware module. A method for a scanner executing scanning comprises displaying a virtual hardware icon in a computer, and the virtual hardware icon corresponding to the scanner for receiving a plurality of commands from the computer. The virtual hardware icon is selected for commanding a command of executing scanning, and then the scanner executes scanning according to the command of executing scanning. Then scanned data is saved.

### BACKGROUND OF THE INVENTION

1. Field of the Invention

The invention relates to a system and method for a scanner executing scanning, and more particularly to a system and method for a scanner set as a virtual hard disk in a computer.

2. Description of the Prior Art

In general, there are two methods for users commanding a scanner to start scanning action. As depicted in FIG. 1 is a flow chart for one of the two methods. First, an image scanner is connected to an external host computer, such as a personal computer, via an electrical cable. The host computer generally includes a display monitor, a storage hard disk, a keyboard, a mouse and a compact disk, and so on. Users need to install the image scanner's driver in the external host computer (step 110). Next, there need to be application program of image software in the external host computer for controlling the image scanner. Users then execute the application program of the image software (step 120). In the application program environment, users select and set the image scanner-related settings, such as data source. Then the image scanner's driver is called through the application program of the image software (step 130). When users command the scanning requirement, the image scanner starts scanning action through the application program via TWAIN-related program and protocol (step 140). Finally, the scanned image data is saved as a file in the external host computer (step 150).

The flow chart of the other method is depicted in FIG. 2. Similarly, the image scanner driver is first installed in the external host computer (step 210). When users operate the image scanner, such as placing an objective image on the platform of the image scanner, a response can be transferred from the image scanner to the external host computer via the electrical cable. The external host computer can monitor the response from the image scanner (step 220) and then automatically execute the application program of image software (step 230). When users command the scanning requirement, the image scanner starts scanning action through the application program via TWAIN-related program and protocol (step 240). Finally, the scanned image data is saved as a file in the external host computer (step 250).

However, there are some disadvantages for both methods mentioned above. First, an application program of image software must be installed in the operating system. The image scanner can't be used without the application program of the image software, that results in the complication of using the scanner. Second, users can't monitor the existence of the scanner in a network, that is, the scanner can't be used as shared source of the network. Third, users need to repeat copy for a scanned image if they want to send the scanned image by the network.

### SUMMARY OF THE INVENTION

It is an object of the present invention to provide a system and method for a scanner executing scanning by using a virtual hard disk device corresponding to the scanner in a computer. In the present invention, the virtual hard disk device is shown in a file management of the computer and users can directly command the scanner by commanding the virtual hard disk device.

It is another object of the present invention to provide a system and method for a scanner executing scanning. Users can directly command the scanner to execute scanning and save a scanned image data in an on-line network.

It is a further object of the present invention to provide a system and method for commanding a scanner starting scanning. Users can control the scanner without any application program of image software.

In the present invention, a system for a scanner executing scanning comprises a virtual hardware module in an electrical apparatus, and the virtual hardware module is corresponding to the scanner and used for receiving a plurality of commands from the electrical apparatus. The virtual hardware module is displayed on the electrical apparatus. A scanner control module in the electrical apparatus is for communicating with the scanner via the electrical apparatus and the virtual hardware module. The scanner control module is for controlling and executing the commands from the virtual hardware module. A method for a scanner executing scanning comprises displaying a virtual hardware icon in a computer, and the virtual hardware icon corresponding to the scanner for receiving a plurality of commands from the computer. The virtual hardware icon is selected for commanding a command of executing scanning, and then the scanner executes scanning according to the command of executing scanning. Then scanned data is saved.

### BRIEF DESCRIPTION OF THE DRAWINGS

A better understanding of the invention may be derived by reading the following detailed description with reference to the accompanying drawing wherein:

FIG. 1 is a flow chart illustrating a scanner executing scanning in accordance with one method of a prior art;

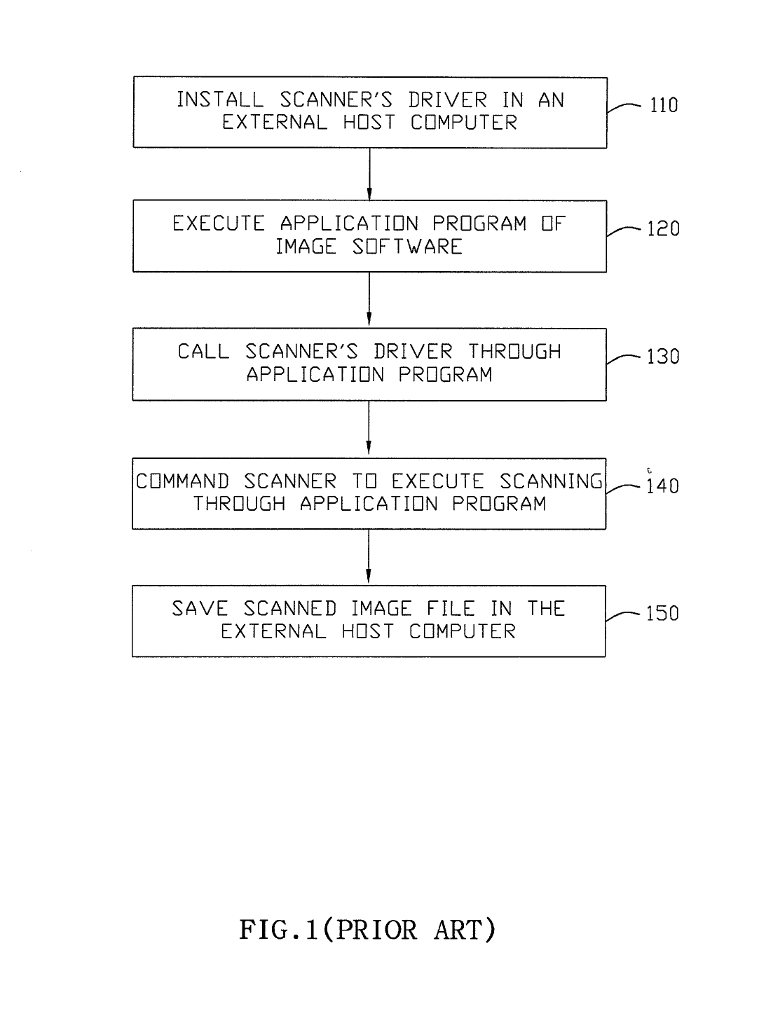

FIG. 2 is another flow chart illustrating the scanner executing scanning in accordance with another method of the prior art;

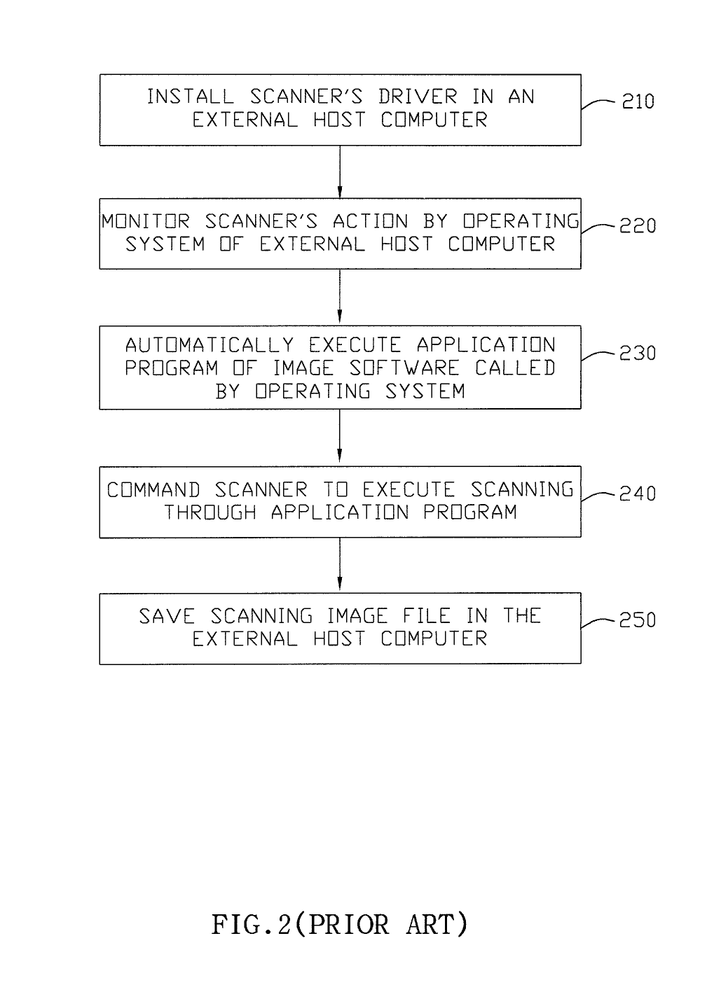

FIG. 3 is a flow chart illustrating the scanner executing scanning in accordance with the present invention;

FIG. 4 is a schematic diagram illustrating users command the scanner executing scanning in a file management of an operating system in accordance with the present invention;

FIG. 5 is a schematic diagram illustrating users command the scanner executing scanning in an application program of image software in accordance with the present invention;

FIG. 6 is a schematic diagram illustrating users connecting with a mail server through a browser and opening an editorial window in a mail editor in accordance with the present invention; and

FIG. 7 is a schematic block diagram illustrating structural block of the present invention.

### DESCRIPTION OF THE PREFERRED EMBODIMENT

While the invention is described in terms of a single preferred embodiment, those skilled in the art will recognize that many steps described below can be altered and that species and types of substrate and dopant as well as other materials substitutions can be freely made without departing from the spirit and scope of the invention.

In the present invention, a system in a computer for a scanner executing scanning comprises a virtual hardware module for receiving and transferring a plurality of commands from the computer. The virtual hardware module is corresponding to the scanner and displayed as a virtual storage device icon in an operating system of the computer. A scanner control module is for communicating with the virtual hardware module and the scanner via the computer, and the scanner control module is for controlling and the commands from the virtual hardware module and transferring the commands to the scanner to executing the commands. A method for a scanner executing scanning comprises displaying a virtual hardware icon in a computer, and the virtual hardware icon corresponding to the scanner for receiving a plurality of commands from the computer. The virtual hardware icon is selected for commanding a command of executing scanning, and then the scanner executes scanning according to the command of executing scanning. Then scanned data is saved.

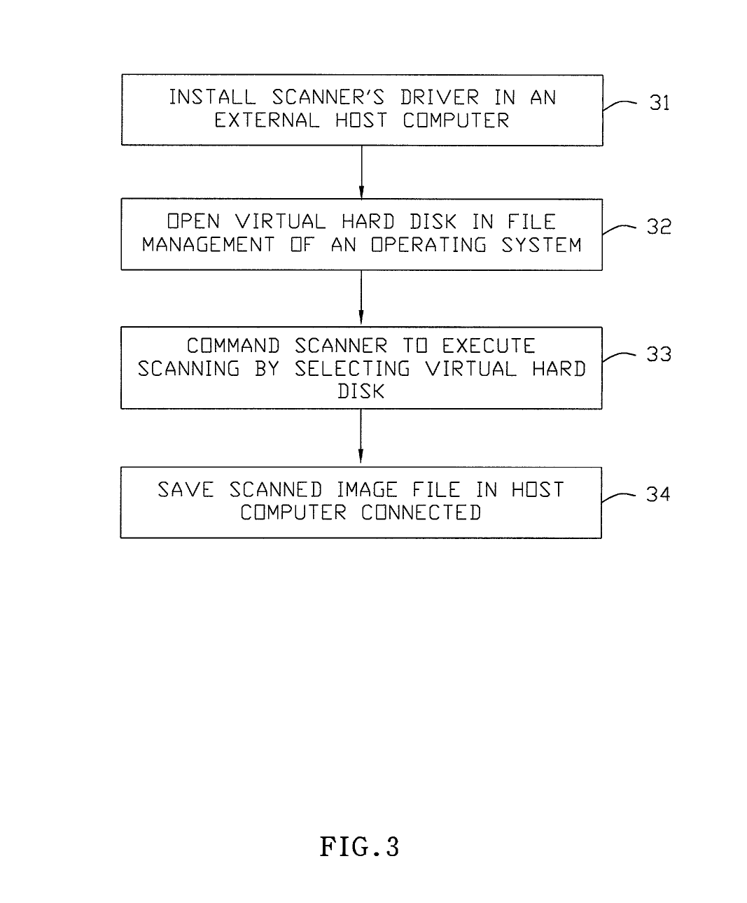

As depicted in FIG. 3 is a flow chart illustrating commanding an image scanner to executing scanning action in accordance with the present invention. First, users need to install the image scanner's driver in an external host computer (step 31). The image scanner is connected to the external host computer via an electrical cable. The external host computer, such as a personal computer or a server computer, can be a computer that can connect to any Internet through any external communication apparatus, such as modem, or one of computers in network. Furthermore, a graphical user interface environment, such as an operating system, is applied in the external host computer. In the embodiment, the Microsoft Windows® is used in the external host computer. Other operating system, such as UNIX or LINUX, also can be applied in the external host computer. Furthermore, an application program of image software, such as Adobe Photoshop, may be installed in the external host computer and is used for image edition and management.

In particular, after installation of the driver for the image scanner, a virtual hard disk device icon, similar as a main hard disk device of the external computer, can be created in the file management of the operating system or the application program. In particular, the virtual hard disk device icon is directly corresponding to the image scanner. User can directly view a scanner object by selecting the virtual hard disk device icon. Of course, the scanner object also can be set on the desktop of the operating system as a quick item. In other words, users can directly copying or moving the scanner object by dragging and dropping. Specifically, when the external host computer is built in a network, users also can view the virtual hard disk device icon and select the scanner object by operating other computer that is not directly connected to the image scanner.

Next, users can select the virtual hard disk device icon in the file management of the operating system in the external host computer (step 32). The scanner object can be shown by selecting the virtual hard disk device icon for use of commending scanning. Furthermore, user can set a quick item for the scanner object on the desktop of the external host computer. On the other hand, the virtual hard disk device icon and its scanner object can be shown by running application program of the image software. That is, the virtual hard disk device icon is used for the virtual hardware of the image scanner, which can be traced through the file management of the operating system no matter that the external host computer is single or connected to the network.

Then, users can prepare an objective image for scanning and command the image scanner to execute scanning action by opening the scanner object, such as double clicking by a mouse (step 33). Instead of conventionally commanding the scanning action through only the application program of the image software, users can directly control the image scanner at local or in remote, as well as control a local or remote printer. There are many advantages for creation of the virtual hard disk device icon in accordance with the present invention. First, users can directly control the image scanner to execute scanning without existence of the application program of the image software and understanding complicated settings of the image scanner. Second, when the external host computer is built in the network, the image scanner can be viewed as a virtual hard disk in a network with the corresponding virtual hard disk device icon. Users can directly know the existence of the image scanner through the file management in the network and further command the scanning action by selecting the scanner file of the external host computer with their own local host computer.

Finally, users can save the scanned image file anywhere (step 34). In the present invention, users can command the image scanner to execute scanning and set a storage path of an image file for saving the scanned image data by dragging or dropping the scanner object in the virtual hard disk device icon. In particular, when users set the path for the scanned image file, they can set the scanned image file saved in remote host computer or their local host computer that is not directly connected to the image scanner. That is, the scanned image file can be saved in any storage apparatus, rather than in the external host computer that is not connected to the image scanner. Users can spend less time in repeating copying the scanner image file and further directly retrieve the scanned image file.

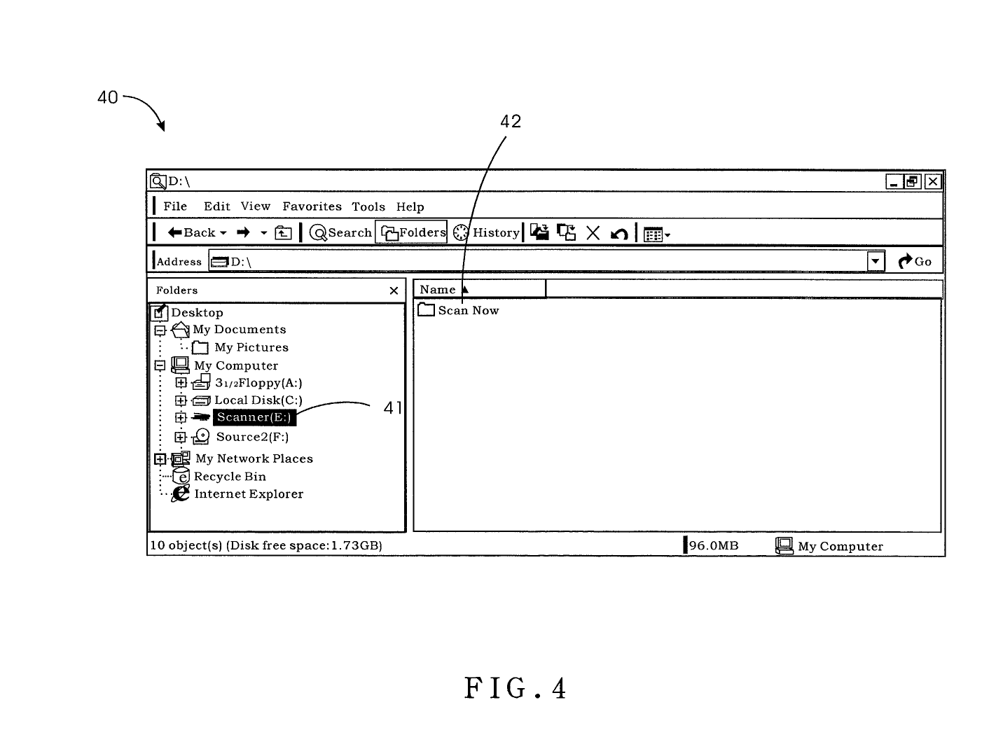

Following drawings illustrate the present invention in detail. According to the step 31 of FIG. 3, after installation of the driver for the image scanner, the virtual hard disk device icon 41 corresponding to the image scanner can be created in the file management interface 40 of the Microsoft Windows, shown in FIG. 4. When user select the virtual hard disk device icon 41, the scanner object 42, such as “Scan Now”, can be display similar as files of a main hard disk. Even the driver of the image scanner is connected with other computer in the network, users still can view the virtual hard disk device icon 41 in the path of files-tree belonging to neighbor computer in the network. Furthermore, the scanner object 42 can be commanded the image scanner to execute scanning by double clicking, or further set the stored location of the scanned image data after being commanded the image scanner by directly dragging and dropping.

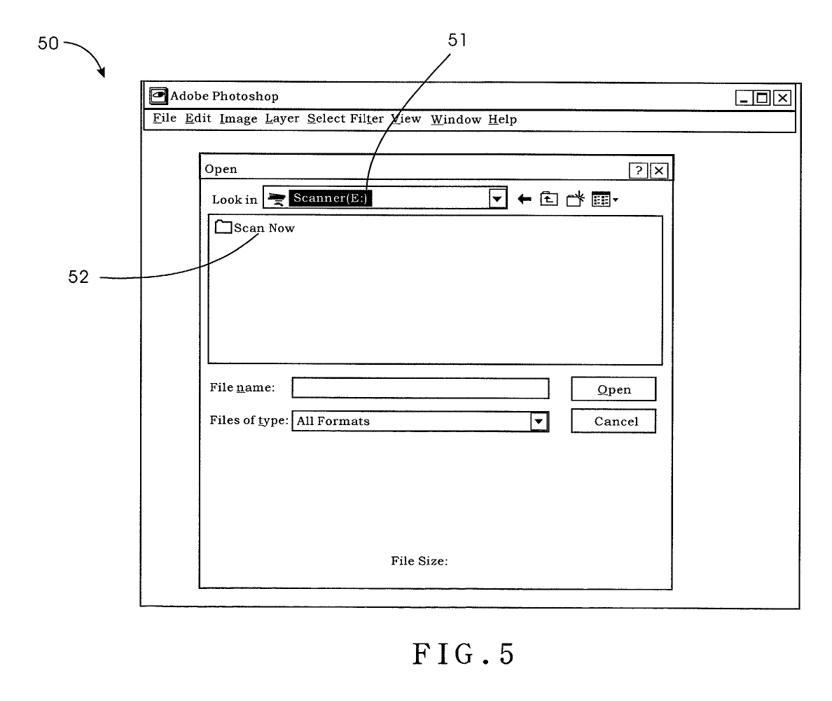

On the other hand, when users execute and enter the application program of the image software in the external host computer directly connected the image scanner, they can find the virtual hard disk device icon and therein the scanner object in the file item. For example, in Adobe Photoshop application program interface 50, user can select the function of “open file” in the file item and find the virtual hard disk device icon 51 and therein the scanner object 52, shown in FIG. 5. For classification, the virtual hard disk device icon 51 is just like a virtual hardware and assigned in the path of the main-files the file management.

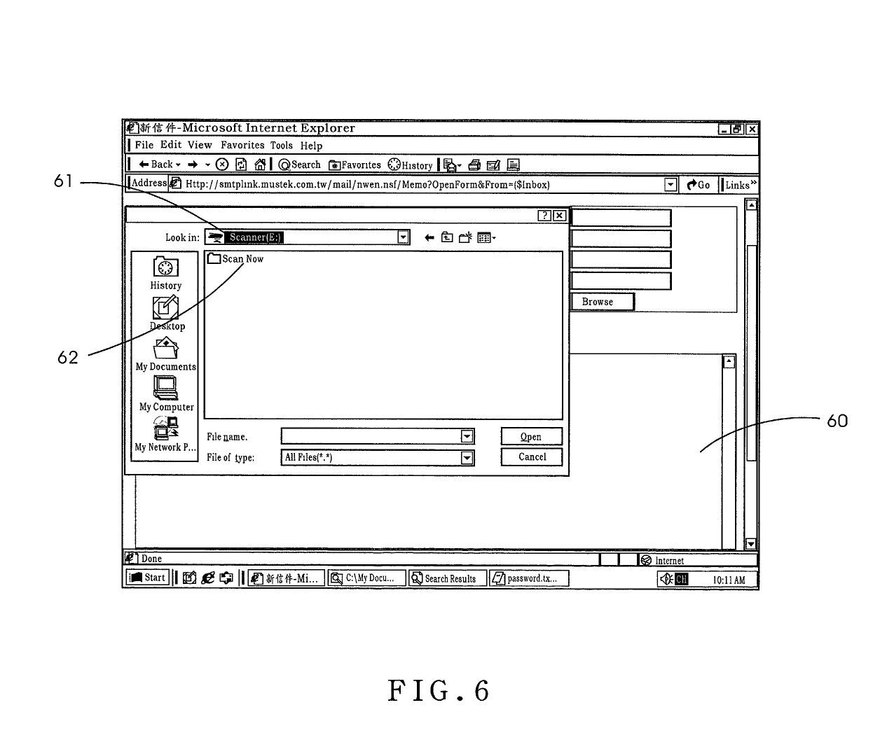

Another example is according to the step 33 of FIG. 3. If users connect with a mail server through a browser and open an editorial window with a mail editor on the browser, they can first create a new mail form 60 shown in FIG. 6. Next, users can search the virtual hard disk device icon 61 with search function and command the scanner object 62 “Scan Now” by double clicking. At the moment, the image scanner corresponding to the scanner object 62 can execute the scanning action, create a scanned image file and then automatically attach the scanned image file into the new mail form 60. Users command the image scanner to start scanning and save the scanning image file without executing the application program of the image software.

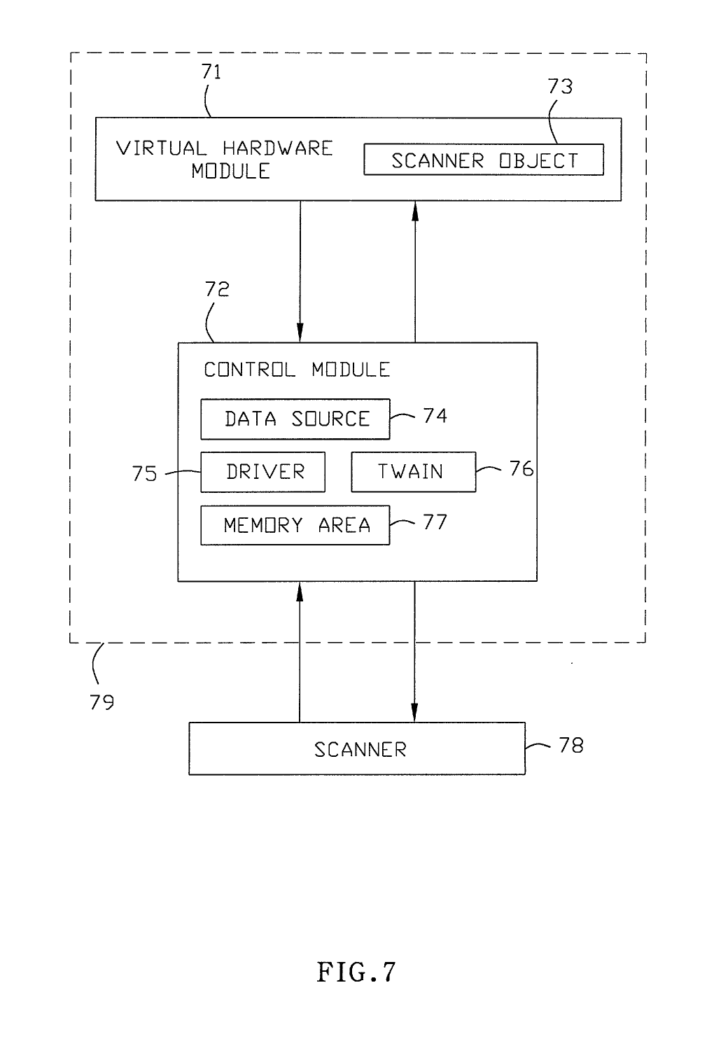

Referring to FIG. 7, depicted therein is a structural block of the system of the present invention including a scanner 78 and scanner software 79 in the external host computer (not shown). In the present invention, when the scanner's driver is installed in the external host computer, it means that whole scanner software 79 is installed in the external host computer. A virtual hardware module 71, displayed as the virtual hard disk device icon corresponding to the scanner, can be created in the file management of the operating system. A scanner object 73 is also included in the virtual hardware module 71. Users can open the scanner object of the virtual hardware module 71 through the file management, application program of the image software, and search function of the on-line network browser application program. In particular, users also can command the scanner 78 to start scanning action by opening the scanner object 73 of the virtual hardware module 71.

The control module 72 includes scanner-related programs (or function), such as data source 74, driver 75, TWAIN 76, and memory area 77. The data source 74 is for configuring the scanner 78. The driver 75 is machine-dependent software or firmware adapted to the scanner 78. The TWAIN 76 is for a multitude of TWAIN-related programs communicating to a TWAIN protocol. The memory area 77 is for storing scanned images. When users open the scanner object 73 of the virtual hardware module 71 by double clicking, the control module 72 is for executing a series of communication and controlling functions. Furthermore, when users open the scanner object 73 of the virtual hardware module 71 by dragging and dropping, besides executing a series of communication and controlling functions, the control module 72 executes copying the scanned images from the memory area 75 to the image file module 73. The image file module 73 is for saving and displaying the scanned image file or files in the external host computer or any outside storage devices.

It is an object of the present invention for users to quickly control the image scanner to start scanning action and directly retrieve the scanning image file to save or send out. In accordance with the present invention, user can easily find the virtual hard disk device icon in the network through the creation of the scanner file in the file management of the operating system.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A system for a scanner executing scanning, said system comprising:
a virtual hardware module in an electrical apparatus, said virtual hardware module corresponding to said scanner and used for receiving a plurality of commands from said electrical apparatus, said virtual hardware module and displaying on said electrical apparatus; and
a scanner control module in said electrical apparatus, said scanner control module communicating with said scanner via said electrical apparatus and said virtual hardware module, said scanner control module for controlling and executing said commands from said virtual hardware module.

2. The system of claim 1, wherein said electrical apparatus comprises:
a storage module and a plurality of application program, said virtual hardware module, and said scanner control module therein;
an input module for selecting said virtual hardware module and inputting said commands;
an output module for displaying said virtual hardware module; and
a control module communicating with said scanner for coordinating said storage module, said input module and output module.

3. The system of claim 1, wherein said virtual hardware module comprises a virtual storage device displayed on said electrical apparatus.

4. The system of claim 3, wherein said virtual storage device comprises a virtual hard disk device icon.

5. The system of claim 1, wherein said virtual hardware module further comprises a scanner object displayed in said electrical apparatus and said scanner object is for receiving said commands from said electrical apparatus.

6. The system of claim 1, wherein said commands comprise opening said virtual hardware module for a command of executing scanning by double clicking.

7. The system of claim 1, wherein said commands further comprise opening said virtual hardware module for a command of executing scanning by dragging and dropping.

8. The system of claim 1, wherein said commands further comprise opening said virtual hardware module for setting a storage location of a scanned data by dragging and dropping.

9. A system in a computer for a scanner executing scanning, said system comprising:
a virtual hardware module for receiving and transferring a plurality of commands from said computer, said virtual hardware module corresponding to said scanner and displayed as a virtual storage device icon in an operating system of said computer; and
a scanner control module communicating with said virtual hardware module and said scanner via said computer, said scanner control module for controlling and said commands from said virtual hardware module and transferring said commands to said scanner to executing said commands.

10. The system of claim 9, wherein said virtual storage device icon comprises a virtual hard disk device icon.

11. The system of claim 9, wherein said virtual hardware module further comprises a scanner object displayed in said operating system and said scanner object is for receiving said commands from said computer.

12. The system of claim 11, wherein said commands comprise opening said scanner object for a command of executing scanning by double clicking.

13. The system of claim 11, wherein said commands further comprise opening said scanner object for a command of executing scanning by dragging and dropping.

14. The system of claim 11, wherein said commands further comprise opening said scanner object for setting a storage location of a scanned data by dragging and dropping.

15. A method for a scanner executing scanning, said method comprising:
displaying a virtual hardware icon in a computer, said virtual hardware icon corresponding to said scanner for receiving a plurality of commands from said computer;
selecting said virtual hardware icon for commanding a command of executing scanning;
executing scanning by said scanner according to said command of executing scanning; and
saving scanned data.

16. The method according to claim 15, wherein said selecting step comprises opening a scanner object of said virtual hardware icon for commanding said command of executing scanning by double clicking with a mouse of said computer.

17. The method according to claim 15, wherein said selecting step comprises opening a scanner object of said virtual hardware icon for commanding said command of executing scanning by dragging and dropping with a mouse of said computer.

18. The method according to claim 15, wherein said selecting step comprises opening a scanner object of said virtual hardware icon for setting a storage location of scanned data by dragging and dropping with a mouse of said computer.

19. The method according to claim 15, wherein said virtual hardware icon comprises a virtual hard disk device icon displayed in an operating system of said computer.

20. The method according to claim 15, wherein said scanner is communicated with said computer through a connecting network.
